(19) United States
(12) Patent Application Publication
(10) Pub. No.: US 2001/0042051 A1
(43) Pub. Date: Nov. 15, 2001

(54) NETWORK TRANSACTION SYSTEM FOR MINIMIZING SOFTWARE REQUIREMENTS ON CLIENT COMPUTERS

(76) Inventors: JEREMEY L. BARRETT, PALO ALTO, CA (US); JOHN A. SWEET, PALO ALTO, CA (US); BENEDICT I. KAVANAGH, SAN FRANCISCO, CA (US)

Correspondence Address: David R. Graham, Esq., 1337 Chewpon Ave., Milpitas, CA, 95035, US

(21) Appl. No.: 09/105,550

(22) Filed: Jun. 26, 1998

(51) Int. Cl. G06F 17/60; H04K 1/00; H04L 9/00

(52) U.S. Cl. 705/65; 705/67

(57) ABSTRACT

A method and apparatus for conducting a transaction over a network is disclosed. The method may include the steps of: using a consumer client to interact with a merchant system; sending a first request from the merchant system to a transaction manager; sending a first response from the transaction manager to the merchant system; relocating the consumer client to the transaction manager; using the consumer client to interact with the transaction manager; relocating the consumer client back to the merchant system; sending a second request from the merchant system to the transaction manager; and sending a second response from the transaction manager to the merchant system. The apparatus may include a transaction manager for use in conducting a transaction over a network. The transaction manager generally includes a database server for storing consumer wallets, a consumer client server configured to provide an interface for a consumer client on the network with the database server and to provide information from one of the consumer wallets to the consumer client, and a remote interface server configured to pass transaction information to a merchant system coupled to the network in response to a request of the merchant system and to pass information from one of the consumer wallets to the merchant system in response to interaction of the consumer client with the consumer client server.

### BACKGROUND OF THE INVENTION

1. Field of the Invention

The present invention relates to electronic commerce over networks, and more particularly, to a network transaction system that is useful for making secure data transfers and transactions over the Internet.

2. Description of the Related Art

Recently, there has been much enthusiasm over the potential for electronic commerce over the Internet. There are currently millions of Internet users around the world and the number of users is expected to continue to grow. Consumers see electronic commerce over the Internet as a potentially convenient way to shop, and merchants see it as a cost-efficient means of enlarging their customer base. Worldwide, it is expected that electronic commerce for consumer goods and services will have massive growth.

One way for consumers to pay for their purchases over the Internet is to enter their credit card information. Such transactions, however, are viewed as high risk due to the non-secure nature of transmitting information “in the clear” over an open network such as the Internet. Some transactions may include a measure of security from encryption technology embedded in consumer and merchant software that protects financial and purchase/personal information. However, the increased security resulting from encryption alone does not provide adequate protection for consumers when transferring sensitive financial data and records (e.g., credit card numbers) from the their personal computers to the merchants' systems.

Other attempts to create secured payment systems over the Internet have had several disadvantages. For example, many of these systems call for special coded software to reside in the consumer's personal computer. Not only is the installation and administration of such software burdensome and costly to the consumer, but also these “software download” requirements prevent the consumer from using the payment system from computers that do not have the special software installed. Other previous secure payment systems only allow the consumer to use a single designated credit card or other payment instrument. These types of systems have the disadvantage of not giving the consumer the flexibility to select from several types of payment instruments or credit cards when making a purchase.

For Internet commerce to fully develop with complete acceptance by consumers and merchants, all parties need a way of verifing each other's identities and establishing trust, all while exchanging records of data used in transactions. Thus, there is a need for a method and apparatus for conducting secure transactions over networks, and in particular, for making secure credit card transactions over open networks such as the Internet, in such a way that a given consumer can readily perform transactions not only swiftly, but also with ease—using any computer that has access to the internet, even if such computer does not have special software installed which makes possible these transactions.

### SUMMARY OF THE INVENTION

The present invention provides a method of conducting a transaction over a network, comprising the steps of: establishing a wallet with a transaction manager; using a consumer client to interact with a merchant system; relocating the consumer client to the transaction manager; and using the consumer client to instruct the transaction manager to pass information from the wallet to the merchant system.

In another embodiment, the present invention provides a method of conducting a transaction over a network, comprising the steps of: using a consumer client to interact with a merchant system; passing information between the merchant system and a transaction manager; and relocating the consumer client to the transaction manager in response to the step of passing information.

In another embodiment, the present invention provides a method of conducting a transaction over a network, comprising the steps of: using a consumer client to interact with a merchant system; relocating the consumer client to a transaction manager; and passing information from the merchant system to the transaction manager during the step of relocating the consumer client.

In another embodiment, the present invention provides a transaction manager for use in conducting a transaction over a network. The transaction manager includes a database server for storing consumer wallets, a consumer client server configured to provide an interface for a consumer client on the network with the database server and to provide information from one of the consumer wallets to the consumer client, and a remote interface server configured to pass transaction information to a merchant system coupled to the network in response to a request of the merchant system and to pass information from one of the consumer wallets to the merchant system in response to interaction of the consumer client with the consumer client server.

In another embodiment, the present invention provides a network transaction system that includes a network, a merchant system coupled to the network, a consumer client for interacting with the network, and a transaction manager, coupled to the network, configured to store consumer wallets, pass transaction information to the merchant system in response to a request of the merchant system, and pass information from one of the consumer wallets to the merchant system in response to interaction with the transaction manager by the consumer client.

In another embodiment, the present invention provides a method of authenticating a communication over a network, comprising the steps of: receiving a client certificate having an authentication block; decrypting the authentication block to obtain a symmetric key; sending the symmetric key with a first challenge to a client; receiving from the client a first signature that is the result of the first challenge being signed using a first secret key that was decrypted using the symmetric key; and verifying the first signature.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

FIG. 1 is a block diagram illustrating a network transaction system in accordance with the present invention.

FIG. 2 is a block diagram illustrating part of the network transaction system of FIG. 1 in more detail.

FIG. 3 is a flow diagram illustrating the operation of the network transaction system shown in FIG. 1.

FIG. 4 is a flow diagram illustrating the operation of the remote interface server shown in FIG. 2.

FIG. 5 is a flow diagram illustrating the operation of the consumer client server wallet module shown in FIG. 2.

FIGS. 6A and 6B is a flow diagram illustrating a connection authentication process in accordance with the present invention as performed by the remote interface server shown in FIG. 2.

FIG. 7 is a flow diagram illustrating the connection authentication process in accordance with the present invention as performed by the merchant client shown in FIG. 2.

FIG. 8 is a block diagram illustrating a client certificate included in the merchant client shown in FIG. 2.

### DETAILED DESCRIPTION OF THE INVENTION

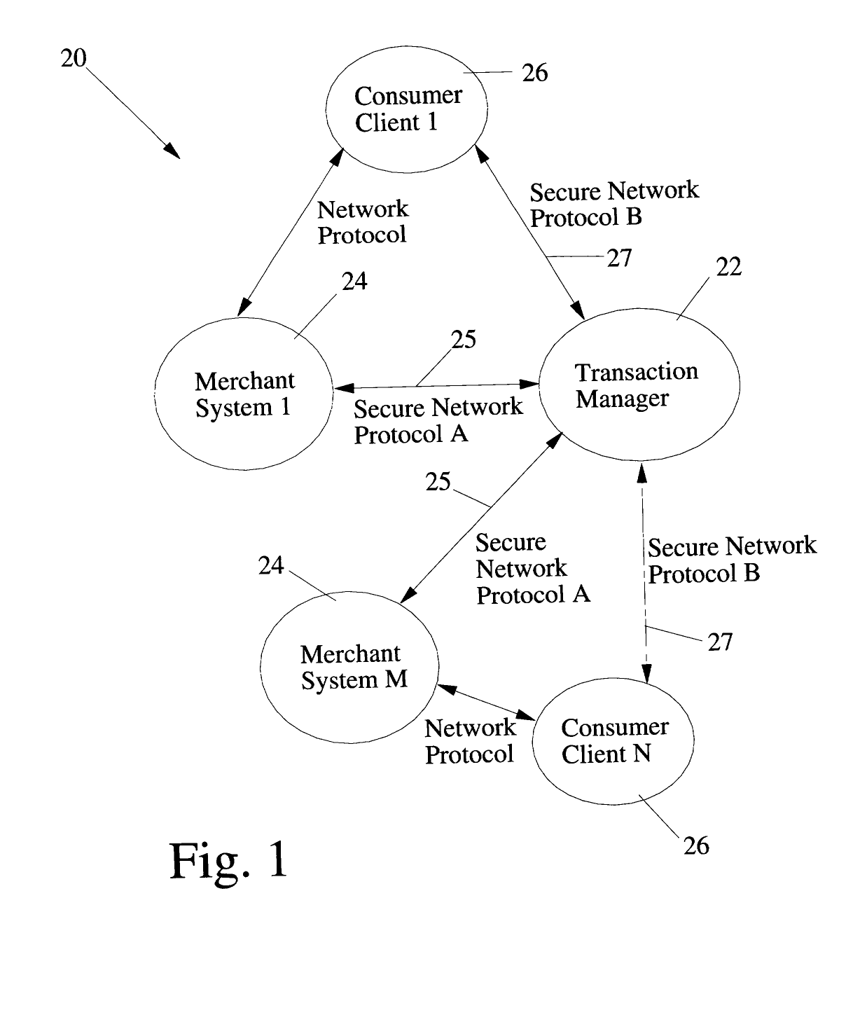

Referring to FIG. 1, there is illustrated a network transaction system 20 in accordance with the present invention. The network transaction system 20 is particularly suited for making secure payments over the Internet, and thus, the remainder of this discussion will be primarily directed to such an implementation. It should be understood, however, that the system 20 could also be used to process other types of transactions over other types of networks. For example, the system 20 could be used to process insurance information, medical information, or any other type of transaction where confidentiality and ease of data transfer is preferred. Furthermore, the system 20 could be implemented in networks other than the Internet, such as for example, intranets, local area networks (LANs), wide area networks (WANs), etc., or any combination of these other networks and the Internet. For example, the network transaction system 20 could be implemented in the network operated by America Online, Inc. of Dulles, Va.

The network transaction system 20 generally includes a transaction manager 22, one or more merchant systems 24, and one or more consumer clients 26. The transaction manager 22 includes hardware and software which stores and manages payment instruments for its users. The users of the transaction manager 22 include consumers, who typically operate the consumer clients 26, and merchants, who typically operate and maintain the merchant systems 24. The merchant systems 24 may provide electronics services such as web sites, store fronts, shopping carts, etc. In the context of the Internet, the merchant systems 24 will normally include merchant web sites, and the consumer clients 26 will normally be “HTTP clients” and may be conventional web browsers. One or more transaction managers 22 normally support and interact awith many consumer clients 26, as indicated by consumer client “N”, and many merchant systems 24, as indicated by merchant system “M”.

The network transaction system 20 provides consumers with a personal “wallet” into which they can store information, such as for example, payment instrument information, such as credit card numbers, ATM card numbers, checking account numbers, etc., as well as other information, such as addresses, phone numbers, shopping receipts, coupons good for discounts at various merchants, frequent flier miles, digital certificates, digital coins, etc. Information for several payment instruments may be kept in the wallet. In general, the wallet is a record or collection of records that is kept in the transaction manager 22 and that is accessed by the consumer with an ordinary consumer client 26, such as a web browser. No other specialized software or plugins are required on a consumer's personal computer to create and use the wallet because the necessary software resides with the transaction manager 22. Thus, a consumer's personal wallet may be thought of as a “server side wallet” because it resides with the transaction manager 22 rather than locally on the consumer's personal computer.

The consumer's personal wallet is keyed on the consumer's identity. The wallet may be a database which includes a collection of data items, where a data item is information about a specific consumer. The wallet may also be thought of as the consumer's account at the transaction manager 22. In one scenario, this account is accessible only after the consumer has presented his or her username and password (which serve in this scenario as the representation of his or her identity) to the transaction manager 22. A “record” from the wallet could be considered to correspond to a specific data item stored in the transaction manager 22 database server 30. Furthermore, the network transaction system 20 could use representations of identity that are different from or in addition to usernames and passwords.

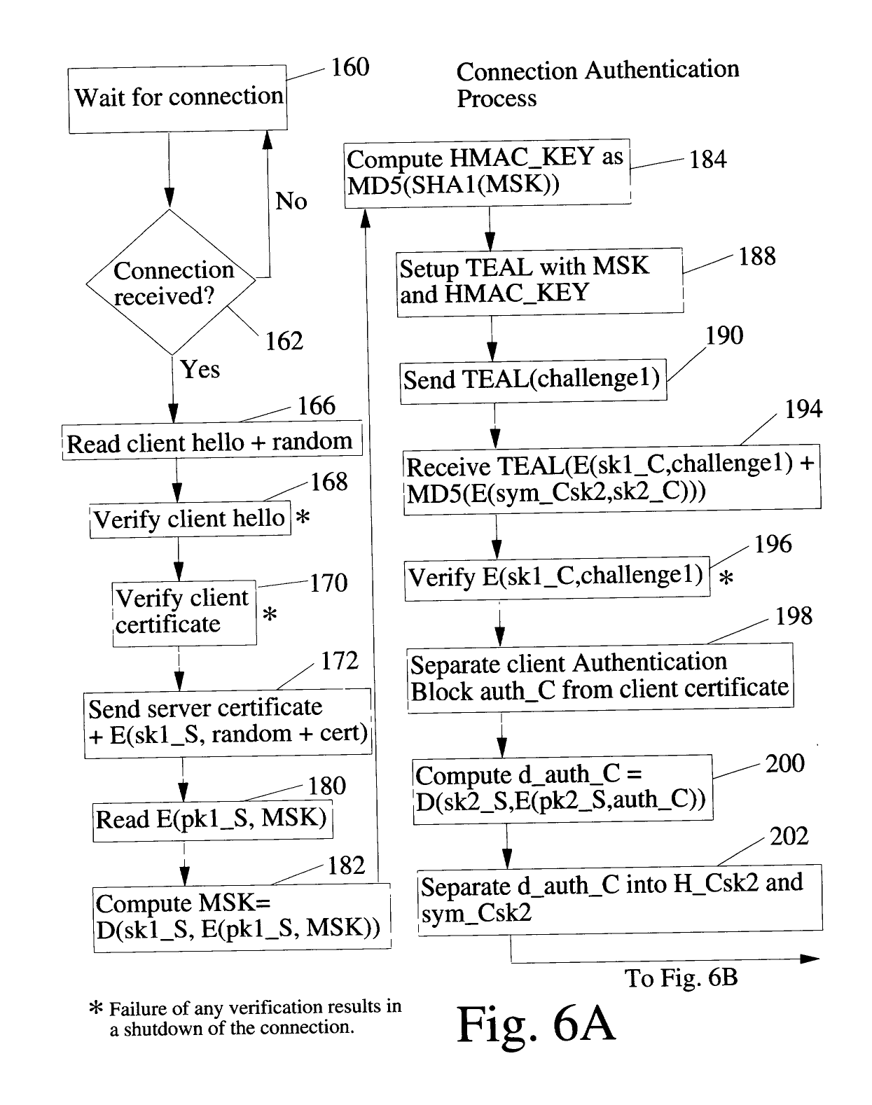

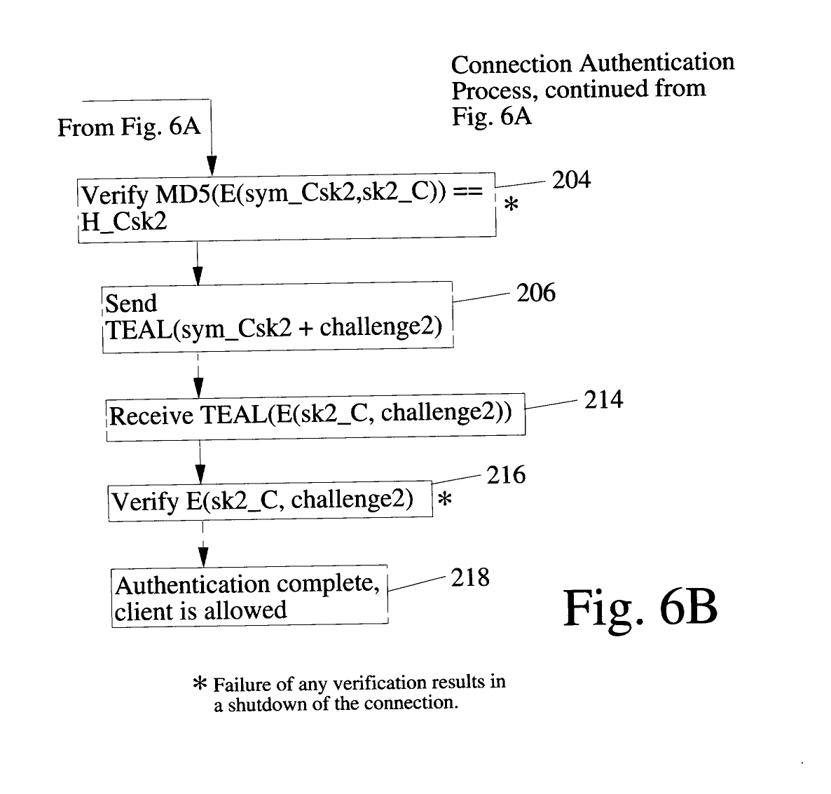

The network transaction system 20 provides merchants and/or sellers access to consumers' payment information by means of a secure network protocol A 25. The secure network protocol A 25 may be any of the well known and currently available secure network protocols, but in a preferred embodiment, the secure network protocol A 25 includes the connection authentication process of the present invention which is discussed below in connection with FIG. 6.

The general operation of the network transaction system 20 is as follows. A consumer first establishes a record having payment instrument information, or a “wallet”, with the transaction manager 22. The consumer may establish his or her wallet in a number of different ways. For example, the consumer may operate one of the consumer clients 26 to visit a web site hosted by the transaction manager 22 and enter the appropriate information, or the consumer may provide the appropriate information directly to the personnel maintaining the transaction manager 22 by mail, telephone, in person, etc., so that the consumer's wallet can be established without sending the information over the Internet. The wallet normally includes the consumer's credit card information and may include other information, such as for example, the consumer's name, billing address, shipping address, etc. One advantage of the present invention is that the wallet may include information for several different credit cards or other payment instruments, such as for example, ATM cards, checking and/or savings account numbers, mutual fund account numbers, etc. Each consumer wishing to use the network transaction system 20 establishes his or her own personal wallet which resides in the transaction manager 22. Establishing the wallet is normally a one time event, except that the wallet may need to be updated if the consumer's payment instrument information or other information changes.

Once the wallet has been established in the transaction manager 22, the consumer then goes shopping by using the consumer client 26 to visit a web site or store front hosted by one of the merchant systems 24. In the context of the Internet, the communication between the consumer client 26 and the merchant systems 24 is normally via the well known (and unsecured) HTTP protocol. The consumer chooses the items to be purchased by interacting with the merchant system 24's web site and then informs the merchant that he or she is ready to make payment (by clicking the appropriate button on the merchant web site). In response to the consumer's payment request, the merchant system 24 initiates communications with the transaction manager 22, during which information is passed between the merchant system 24 and the transaction manager 22. The communications ultimately result in the consumer client 26 being relocated to the transaction manager 22's web site. Furthermore, the communications which take place between the merchant system 24 and the transaction manager 22 are preferably conducted using the secure network protocol A 25. Such secure network protocol may be any of the well known secure protocols available today, such as for example, Secure Sockets Layer (SSL) or Transport Layer Security (TLS). In a preferred embodiment, however, the merchant systems 24 communicates with the transaction manager 22 using the connection authentication process of the present invention, which will be described in detail below in connection with FIG. 6.

The consumer client 26 is relocated to the transaction manager 22's web site so that the consumer can choose one of the payment instruments and other data from his or her wallet to complete the transaction. The relocation of the consumer client 26 is necessary because the consumer's wallet resides in the transaction manager 22. Communication between the consumer client 26 and the transaction manager 22 may be conducted via unsecured network protocols, such as HTTP in the context of the Internet, or preferably via secure network protocol B 27, which in the context of the Internet may be SSL. The consumer chooses a payment instrument by interacting with the transaction manager 22's web site. By interacting with the transaction manager 22's web site and choosing a payment instrument, the consumer is effectively using the consumer client 26 to instruct the transaction manager 22 to pass information from the wallet (i.e. record) to the merchant system 24. After a payment instrument is chosen, the consumer client 26 is relocated back to the merchant system 24. The merchant system 24 requests payment data from the transaction manager 22 and then informs the consumer client 26 of the results of the transaction, i.e., whether the transaction was successfully processed or not.

As discussed above, conventional internet payment systems often require special software to reside and run on the consumer's personal computer. In contrast, the network transaction system 20 of the present invention provides consumers access to their wallets, which reside on the transaction manager 22, via standard network protocols (e.g., standard World Wide Web protocols in the context of the Internet) and does not require that they have specialized software on their computers. The consumer only needs to have an ordinary consumer client 26, such as an ordinary web browser, installed on his or her computer to use the network transaction system 20. Because none of the software or data bases required to operate the network transaction system 20 resides on the consumer's personal computer (except the consumer client 26), the consumer's wallet may be referred to as a “server side wallet” in that the software required to make the system 20 function resides in the transaction manager 22.

The consumer clients 26, which in the context of the Internet are normally HTTP clients or “web browsers”, may be of any of the conventional types which are in wide use today. For example, any of the web browsers available from Netscape Communications of Mountain View, Calif., or Microsoft Corporation of Redmond, Wash., may be used. The consumer clients 26 may also be of the type which is integrated with the computer's operating system, such as is currently being proposed by Microsoft Corporation. It may also be the type of client which is used in the America Online, Inc. system, or rather, an AOL client. The consumer clients 26, as well as the computers on which they run, do not require any special modification or additional software to operate in accordance with the present invention. This is an advantage that the present invention has over previous internet payment systems which, as discussed above, often require that special software reside in the consumer's personal computer. Because such special software is not required, consumer may access their wallets with any web browser installed on any computer.

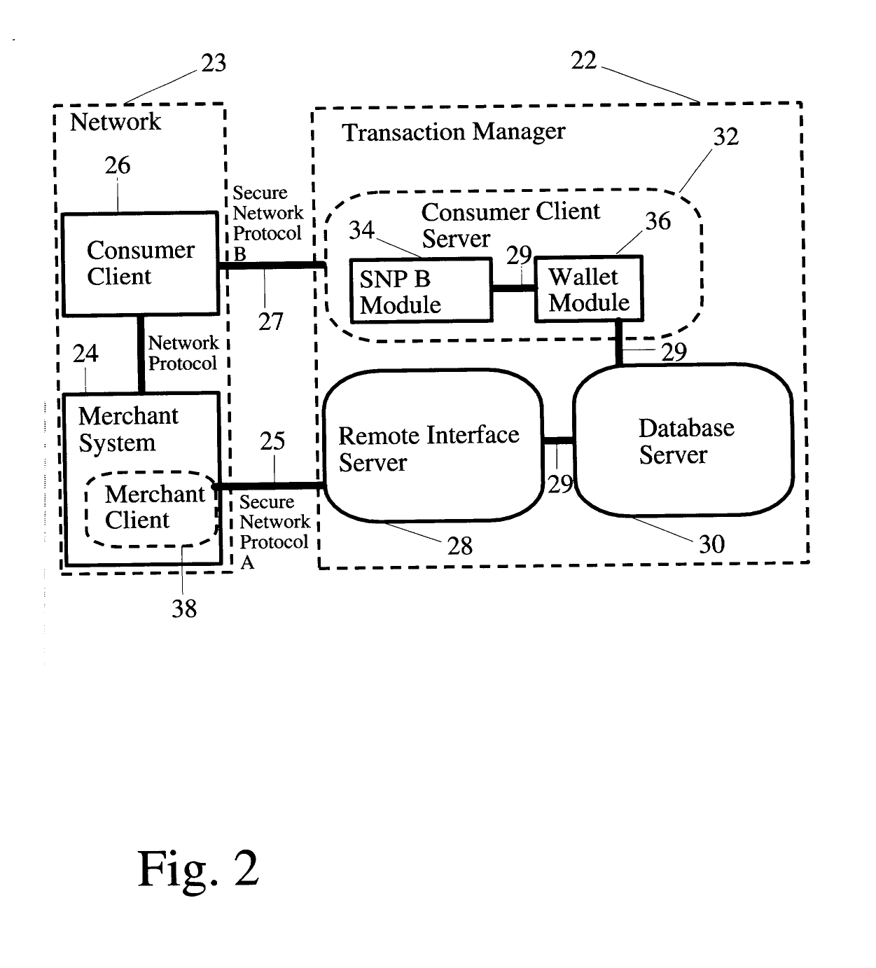

Referring to FIG. 2, the transaction manager 22 may be a collection of software running on one or more computers that is/are coupled to the network 23. As used herein, the term “server” refers to a piece of software which runs continuously on a computer and provides responses to an established set of requests, issued by “clients”. The term “client” refers to a piece of software which makes requests of a server. Clients can be located on the same computer as the server, or they can be located on computers distributed across the Internet.

The transaction manager 22 may include the following modules: a remote interface server 28, a database server 30, and a consumer client server 32. These modules communicate with each other via the interprocess communication channels 29. The channels 29 may be contained within one computer if the modules 28, 30 and 32 are all run on one computer. If the modules 28, 30 and 32 are distributed across more than one computer, then at least some of the channels 29 will be between separate computers.

The remote interface server 28 is a piece of software which provides an interface to the merchant system 24, and in particular, the merchant client 38 which is discussed below. The consumer client server 32 includes a secure network protocol B module 34, which is able to talk to generic web browsers, such as the consumer client 26, and a wallet module 36. In the context of the Internet, the secure network protocol B module 34 may be comprised of well-known and available software which implements generic SSL and HTTP protocols for transferring data between the consumer client server 32 and the user's consumer client 26. The wallet module 36 is software which provides a Graphical User Interface (GUI) for display by the consumer clients 26, and it provides the interface between the consumer client server 32 and the database server 30.

The database server 30 is a piece of software which stores and manages data, and responds to commands and queries of its clients. Its clients consist of the wallet module 36 and the remote interface server 28. In particular, the database server 30 is used to store the consumers' personal wallets, i.e., the records of the consumers' payment instrument information. The wallet module 36 is used in managing the consumers' personal wallets in the database server 30. By way of example, the wallet module 36 may be implemented using the Common Gateway Interface (CGI) to HTTP servers (web servers).

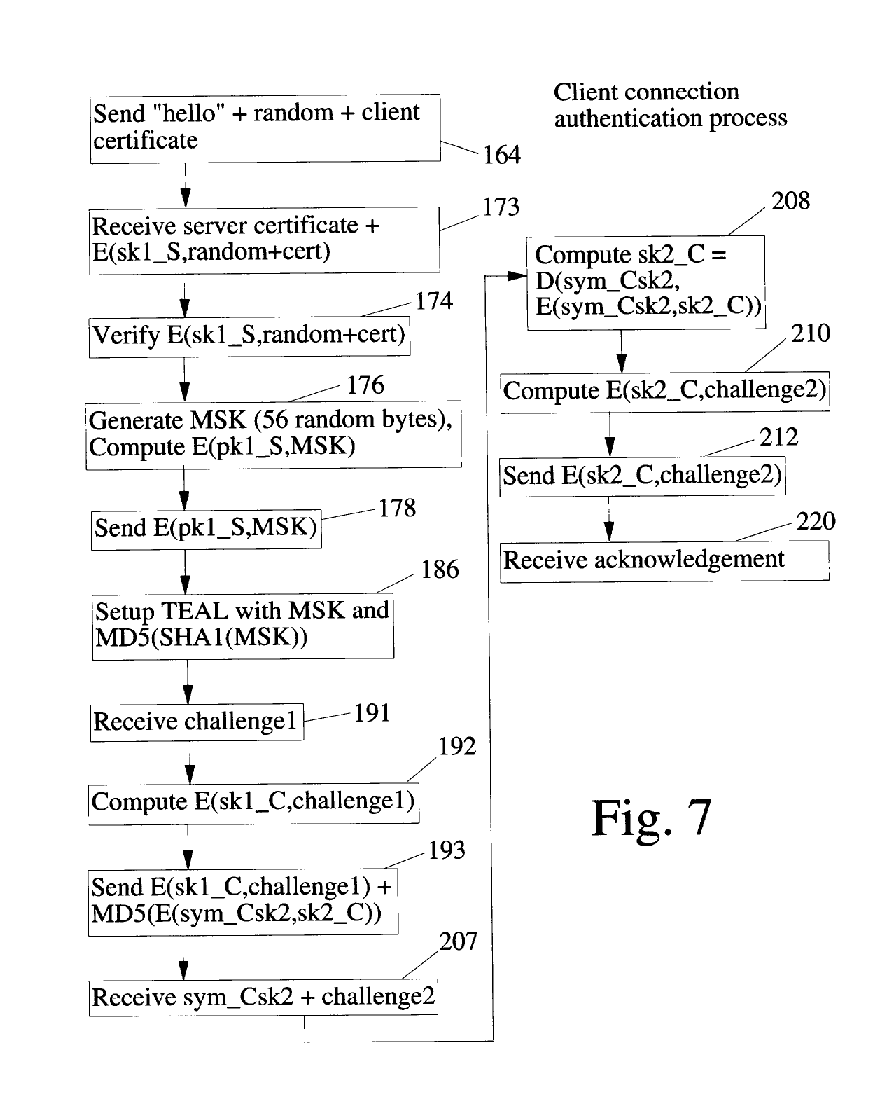

The merchant systems 24 will normally include merchant servers which provide electronic services such as shopping carts, store fronts, web sites, content services, etc. In the context of the Internet, the merchant servers will normally host merchant web sites which may be of the conventional type which are in wide use today. In a preferred embodiment, however, the merchant systems 24 will include a merchant client 38 in accordance with the present invention, and in that regard, the merchant systems 24 will not be conventional. The merchant client 38 is a piece of software residing at the merchant's web site that is responsible for sending transaction requests to the remote interface server 28. The merchant client 38 is used in implementing the connection authentication process of the present invention and will be discussed below in connection with FIG. 7.

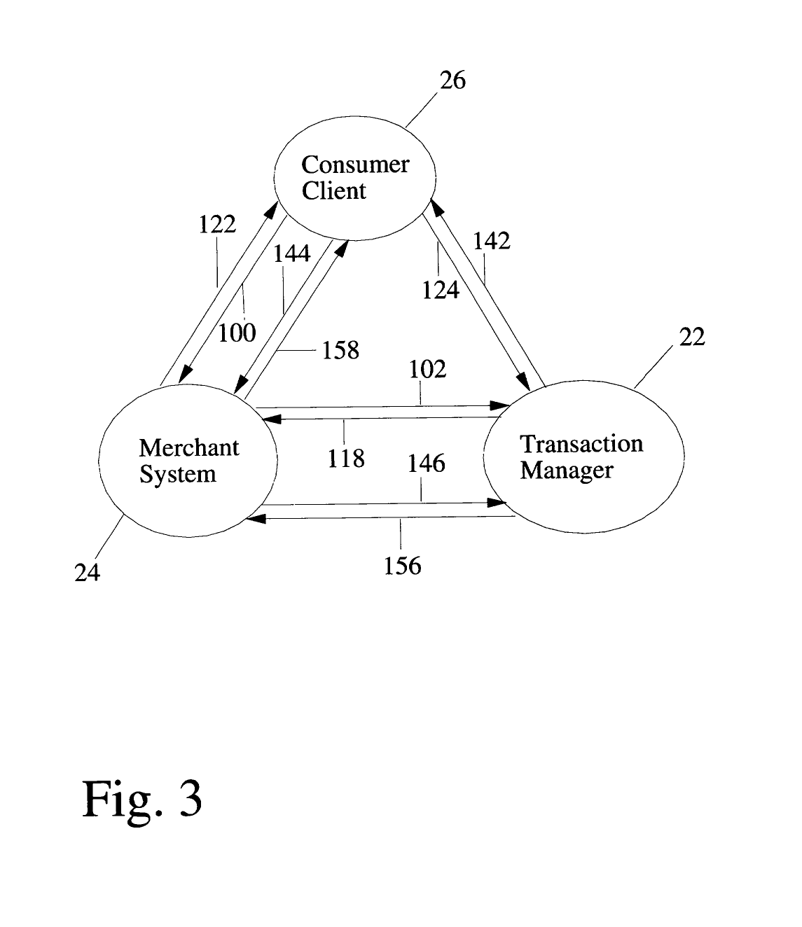

Referring to FIG. 3, the detailed operation of one embodiment of the network transaction system 20 will now be described. In the embodiment shown in FIG. 3, the consumer client 26 is relocated to the transaction manager 22 one time and then relocated back to the merchant system 24 one time. It should be well understood, however, that the consumer client 26 may be relocated to the transaction manager 22 more than one time in accordance with the present invention. For example, the consumer client 26 may be relocated to the transaction manager 22 more than one time in order to verify shipping information or other information with the merchant system 24 before completing the transaction.

With respect to FIG. 3, it is assumed that the consumer has already established his or her wallet with the transaction manager 22. The consumer then operates the consumer client 26 to visit a web site hosted by the merchant system 24 to go shopping. The consumer chooses the items to be purchased and then informs the merchant system 24 that he or she is ready to make payment. The consumer informs the merchant of such by clicking the appropriate button on the merchant's web site. The consumer's request to make payment is indicated by arrow 100.

In response to the consumer's request to make payment, the merchant system 24 ends a transaction request to the transaction manager 22, indicated by arrow 102. Specifically, the merchant system 24 sends a “new request” message to the transaction manager 22. A new request message indicates the initiation of a new transaction and may include an empty transaction ID, the merchant's return Universal Resource Locator (URL), the type of information requested (e.g. payment), the merchant's name, the amount of the payment or transaction, a description of transaction, and the forms of payment the merchant will accept. It should be well understood, however, that the new request message may include more, less, or additional information. A URL is the address of a document on the world wide web or other network.

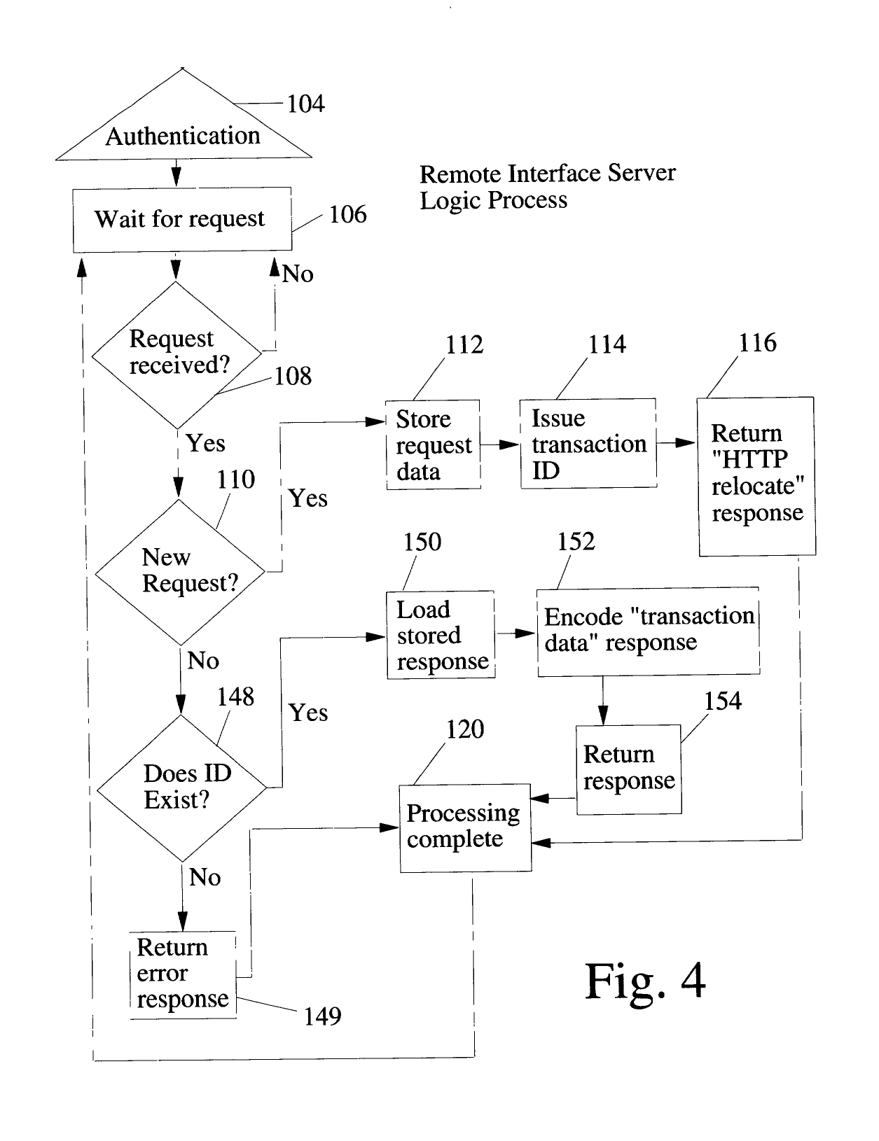

FIG. 4 is a flow diagram of the remote interface server 28 logic process and illustrates the manner in which the merchant's transaction request is processed. The remote interface server 28 first authenticates the merchant's request in step 104. The authentication technique which is used may be any well known authentication technique, but preferably the authentication step 104 uses the server connection authentication process of the present invention (discussed below). After step 104, the remote interface server 28 waits to receive a request, as indicated by steps 106 and 108. When a request is received, a determination is made in step 110 as to whether it is a new request. Because this is a new request, the request data, including the merchant's return URL, the amount of the payment, a description, and the forms of payment the merchant will accept, is stored in step 112, and a transaction ID is issued in step 114.

In step 116, the remote interface server 28 sends an “HTTP relocate” response to the merchant system 24, indicated by arrow 118. The HTTP relocate response includes a URL to which the consumer's consumer client 26 is to be relocated. Also included in the HTTP relocate response is a transaction ID. If the merchant system 24 sent a new request, this is a newly issued transaction ID which will normally be stored by the merchant system 24. Thus, the HTTP relocate response includes a relocation URL and a transaction ID.

It is important to note that the HTTP relocate response is normally not an actual relocation header, but rather an instruction for the merchant system 24 to create and issue a relocation header to the consumer client 26 with the URL. The URL included in the HTTP relocate response is normally the URL of the transaction manager 22's secure network protocol B module 34. After step 116, the remote interface server 28 completes processing in step 120 and waits for another request in step 106.

Next, the merchant system 24 issues an HTTP relocation header to the consumer client 26, indicated by arrow 122. The relocation header relocates the consumer client 26 to the URL that was provided to the merchant system 24 in step 116. Again, this URL is normally the URL of the transaction manager 22's secure network protocol B module 34 because that is where the consumer will choose one of the payment instruments from his or her wallet. Thus, the consumer client 26 is relocated to the transaction manager 22's secure network protocol B module 34.

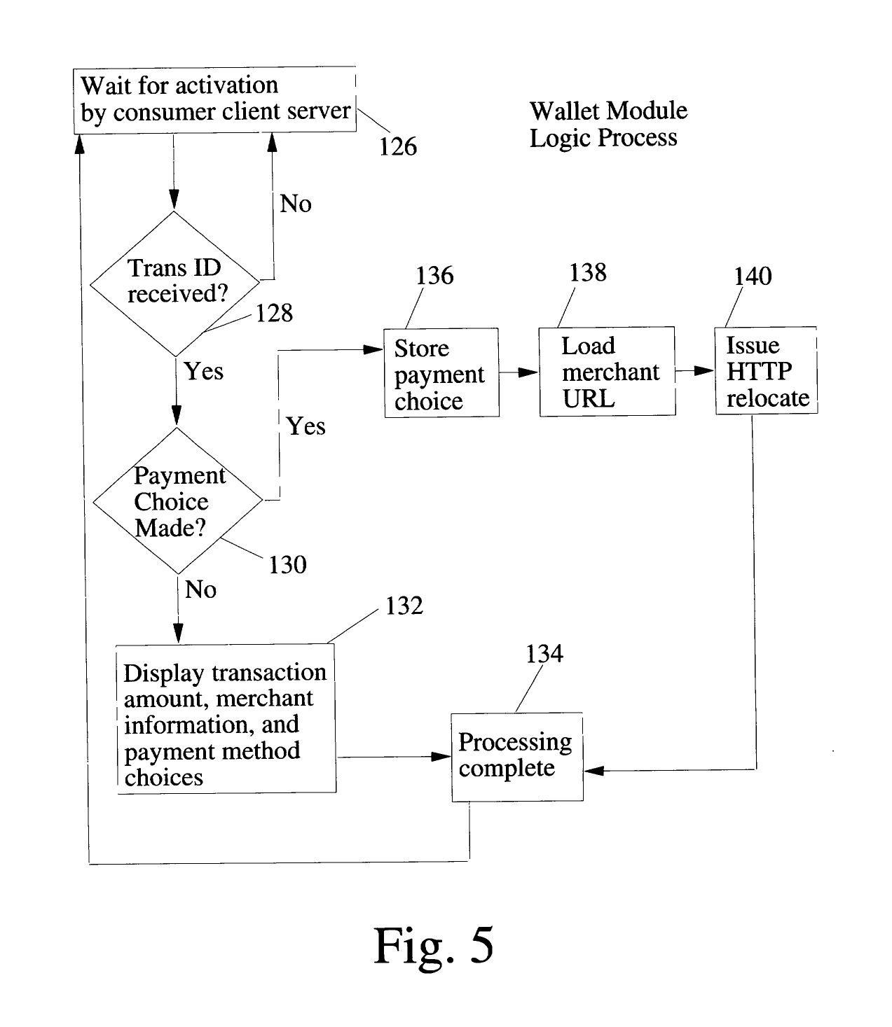

The consumer client 26 contacts the secure network protocol B module 34's web site, as indicated by arrow 124. Referring to FIG. 5, the consumer client server 32's wallet module 36 is then invoked with the transaction ID as the argument. Specifically, the wallet module 36 waits for activation by the consumer client server 32, as shown in step 126. When activated, the wallet module 36 verifies in step 128 that a transaction ID has been received, and then in step 130 determines whether or not a payment choice has been made. At this point no payment choice has been made. Therefore, the transaction information, i.e., the consumer's payment method choices, the transaction amount, and the merchant information, is displayed on the consumer client 26 in step 132. In other words, the consumer's wallet is displayed so that he or she can choose a payment instrument to be used for completing the transaction. Once the payment choices are displayed on the consumer client 26, the wallet module 36 completes processing in step 134 and returns to step 126 to wait for a response by the consumer, i.e., wait for the consumer to choose a payment instrument.

The consumer chooses a payment instrument or method by using the consumer client 26 to click the appropriate button on the displayed payment information. The consumer also instructs the consumer client server 32 to return that payment information to the merchant system 24. This action by the consumer again activates the wallet module 36, where it verifies receipt of a transaction ID and selection of a payment option in steps 128 and 130, respectively. Because a payment choice has been made, the choice is stored during step 136. In step 138, the URL of the merchant web site, which was delivered to the remote interface server 28 and stored in step 112, is loaded into a response.

The ultimate goal of step 140 is for the wallet module 36 to relocate the consumer client 26 to the merchant system 24's web site, i.e., the URL of step 138. This relocation may be accomplished in a couple of different ways. First, the most direct way is for the consumer client server 32 to issue a relocation header to the consumer client 26. Such relocation header would immediately relocate the consumer client 26 to the merchant system 24. This type of direct relocation, however, is not permitted by many available web browsers because of the secure SSL communications which take place between the consumer client 26 and the consumer client server 32. Instead, these types of web browsers require that a security warning be displayed to the user which indicates that the user is leaving a secured communication channel. The user cannot actually leave the secured communication channel until clicking the “continue” button on the security warning. This extra step imposes an additional burden on the consumer and slows down the processing of the transaction.

Another option for achieving the goal of step 140, and which prevents the consumer from encountering the above described security warning, is for the consumer client server 32 to send a content header having a new web page as its content with such web page containing a link (URL) to the merchant system 24. In this scenario the consumer client 26 will display the new web page which will have a link back to the merchant system 24. The consumer simply clicks the link to have the browser 26 relocated to the merchant system 24.

Whatever method is used to implement step 140, the communication between the consumer client server 32 and the consumer client 26 is indicated by arrow 142. This results in the consumer client 26 being relocated to the merchant system 24's web site and the wallet module 36 completing processing in step 134 and waiting for additional activation in step 126.

The consumer client 26 contacts the merchant system 24, as indicated by arrow 144. This time, the consumer client 26 provides the transaction ID to the merchant system 24. The consumer client 26 received the transaction ID from the consumer client server 32. In response to receiving the transaction ID from the consumer client 26, the merchant system 24 sends a “data request” message, identified by the transaction ID, to the remote interface server 28, indicated by arrow 146. A data request message normally includes the same information as a “new request”, except that the transaction ID is included and is not empty.

Referring to FIG. 4, the remote interface logic 28 authenticates the data request in step 104 and verifies that a request was received and that it is not a new request in steps 106, 108 and 110. In step 148 the remote interface server 28 determines whether or not a transaction ID exists. If a transaction ID does not exist the remote interface server 28 will return an error response in step 149. Because a transaction ID does exist in the present scenario, however, the remote interface server 28 retrieves the consumer's payment data (i.e., choice of payment instrument) from the database 30 and loads it into a “data response” in step 150. The data response includes the data requested by the merchant system 24, including, the transaction ID, the type of data being returned, and the data being returned. The data response is encoded in step 152, tagged as payment data, and returned to the merchant system 24 in step 154, indicated by arrow 156.

Once the merchant system 24 receives the payment data from the remote interface server 28, the transaction is complete from the perspective of the transaction manager 22. The merchant system 24 can either process or defer processing of the received payment data as dictated by their own policy, after which the consumer client 26 will be informed of the results, indicated by arrow 158. Such results may include an indication that the consumer's purchase was successfully completed or that the purchase was denied.

While FIG. 3 shows the relocation of the consumer client 26 to the transaction manager 22 only one time, it should be understood that the consumer client 26 may be relocated to the transaction manager 22 more than one time. For example, in such a scenario the consumer client 26 may be relocated to the transaction manager 22 a first time so that the consumer can choose a first set of information, such as shipping information. The consumer client 26 would then be relocated to the merchant system 24 where the merchant would verify that the shipping information is acceptable. The consumer client 26 is then relocated to the transaction manager 22 a second time where the consumer chooses a payment instrument. The consumer client 26 is then relocated back to the merchant system 24 to complete the transaction. If there are multiple relocations to the transaction manager 22, it should be understood that the type of information handled during each relocation may vary. For example, payment instrument information, shipping information, or other information may be handled on the first, second, third, etc. relocation.

FIG. 3 also shows that the merchant system 24 communicates with the transaction manager 22 before relocating the consumer client 26. During this communication the merchant system 24 passes transaction information to the transaction manager 22. In a scenario where the merchant system 24 generates the transaction ID, the merchant system 24 would normally pass the transaction ID to the transaction manager 22 during this communication, i.e., before the consumer client 26 is relocated. It should be understood, however, that the merchant system 24 could pass transaction information, such as the transaction ID, to the transaction manager 22 during the step of relocating the consumer client 26. This would be done by appending the transaction information to the URL (i.e., address) of the transaction manager 22 that is carried by the consumer client 26. In other words, when the merchant system 24 issues the relocation header to the consumer client 26, the relocation header will include the transaction information in the URL.

Referring to FIGS. 6A and 6B, there is illustrated a flow diagram of a server connection authentication process in accordance with the present invention. The server connection authentication process of FIGS. 6A and 6B is normally run by the remote interface server 28 and may be used as the authentication step 104 of FIG. 4. FIG. 7 illustrates the connection authentication process from the perspective of the merchant client 38 (of the merchant system 24). Although the operation of the server connection authentication process will be described with respect to the remote interface server 28 and the merchant client 38, it should be understood that the process could be used to authenticate communications between any server and any client.

In general, the server connection authentication process begins with the remote interface server 28 and the merchant client 38 exchanging “certificates.” Clients often use “certificates” and corresponding secret (or private) keys to prove their identities to a server for access to some service or information. Certificates are normally public knowledge, and contain public information.

After exchanging certificates, the merchant client 38 generates a Master Session Key (MSK) which is sent to the remote interface server 28. The remote interface server 28 uses the MSK to compute a Message Authentication Code key (HMAC_KEY). The MSK and HMAC_KEY are used for sending messages in a next layer of authentication referred to herein as the transport encryption authentication layer (TEAL). The TEAL messages are encrypted with the MSK and authenticated with the HMAC_KEY.

A first set of TEAL messages are exchanged between the merchant client 38 and the remote interface server 28. Then, a second set of TEAL messages are exchanged wherein the server 28 decrypts the authentication block to obtain a symmetric key which it sends to the client 38. The client 38 uses the symmetric key to decrypt its secret key.

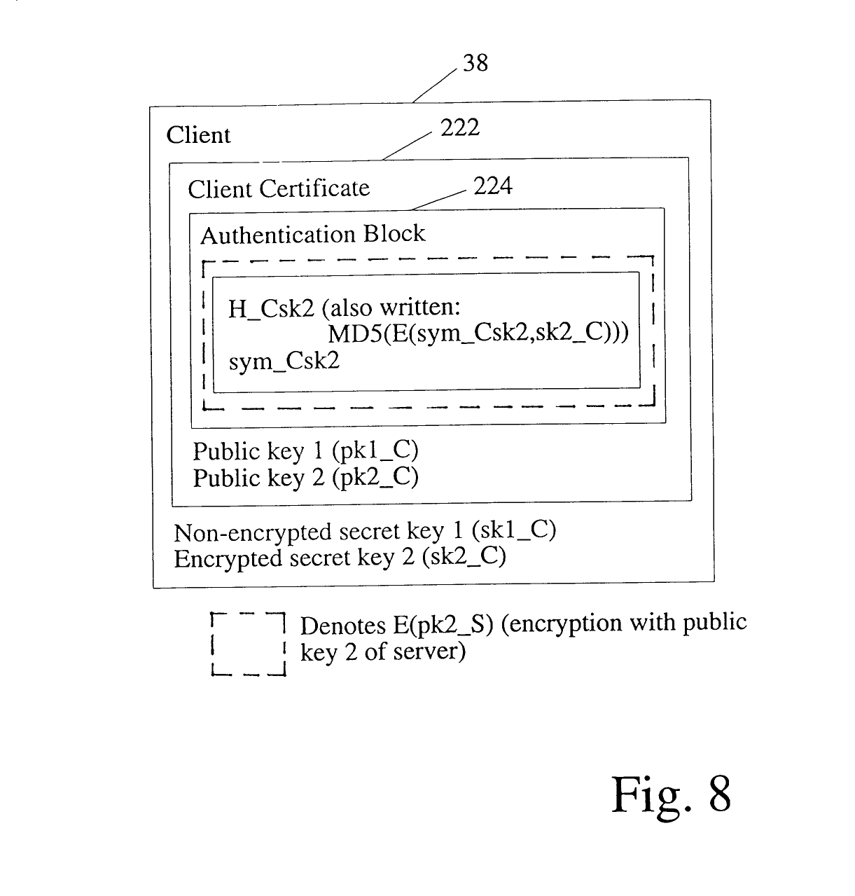

Referring to FIG. 8, the client certificate 222 will normally originate from the merchant client 38, but it should be understood that the certificate 222 could originate from elsewhere. The merchant client 38 will include a non-encrypted secret key 1 (sk1_C) and an encrypted secret key 2 (sk2_C). The certificate 222 includes public key 1 (pk1_C) and public key 2 (pk2_C). The certificate 222 also includes an authentication block 224 which includes a hash of the encrypted secret key 2 H_Csk2 (also written MD5(E(sym_Csk2, sk2_C))), as well as a symmetric key sym_Csk2. An authentication block is a piece of private server data stored in a public certificate to be used for authentication purposes. The authentication block 224 is normally stored in the certificate 222 encrypted with the public key of the server.

Specifically, public client certificates may be used in a manner which gives them private server attributes. A server is often required to store and maintain per-client information to be referenced during transactions, or for further authentication. This private information can be stored in the client's public certificate, in such a way that only the server can extract it, removing the burden of maintaining a database on the server side. The clients necessarily act as a distributed, on-demand database for the server. Therefore, the remote interface server 28 obtains the merchant client 38's symmetric key from the merchant client 38's own public certificate and provides the symmetric key to the merchant client 38 so that it can decrypt its own secret key. After the second set of TEAL messages are exchanged and verified, the authentication is complete and the merchant client 38 is allowed to send a request to the remote interface server 28.

With respect to the detailed operation of the connection authentication process, in steps 160 and 162 the remote interface server 28 waits to receive a connection. In step 164 the merchant client 38 sends a “hello” message, including its certificate, followed by 20 random bytes.

In steps 166, 168 and 170 the remote interface server 28 reads the merchant client 38's “hello” message, verifies that it is a correctly formatted “hello” message, and then verifies the merchant client 38's certificate. Failure of any verification steps, such as steps 168 and 170, results in a shutdown of the connection. In response to the merchant client 38's certificate being verified, the remote interface server 28 signs its own certificate and the 20 random bytes sent in step 164, and then sends its certificate, signature and random bytes to the merchant client 38, all in step 172.

At this point in the discussion it is helpful to define the terms which are used in FIGS. 6A, 6B,7 and 8:

E(x,y) denotes the encryption with key x of data y, i.e., encryption of y with x key;

D(x,y) denotes the decryption of data y with key x;

E(sk_X,y): digital signature on data y using secret key sk_X;

E(pk_X,y): public-key encryption of data y using public key pk_X;

D(sk_X,y): secret-key decryption of data y using secret key X;

sk_X denotes the secret (private) key of X;

pk_X denoted the public key of X;

sym_Xsk denotes the symmetric key used to encrypt X's secret key;

TEAL(x) denotes x encrypted and encoded in a TEAL message;

| denotes concatenation;

Verification of E(sk_Xy) denotes checking (Ta==Th) where:

Ta=D(pk_X(E(sk_XH(y))),

Tb=H(y);

S denotes server, in this scenario the remote interface server 28;

C denotes client, in this scenario the merchant client 38;

HMAC: well known keyed message authentication algorithm, or “keyed hash”;

MD5: well known hash algorithm;

SHA1: well know hash algorithm;

hash: a one way function or algorithm;

sk1_S: first secret key of server;

sk2_S: second secret key of server;

sk1_C: first (unencrypted) secret key of client;

sk2_C: second (stored encrypted with sym_Csk2) secret key of client;

pk1_S: first public key of server (paired with sk1_S);

pk2_S: second public key of server (paired with sk2_S);

pk1_C: first public key of client (paired with sk1_C);

pk2_C: second public key of server (paired with sk2_C);

sym_Csk2: symmetric key used to decrypt sk2_C, stored in authentication block of client certificate; and

H_Csk2: equivalent (in a valid transaction) to MD5(E(sym_Csk2,sk2_C)), described as a hash of the client's encrypted secret key 2.

A symmetric key is a “standalone” key. Both parties normally must have the same symmetric key to encrypt and decrypt communications to each other using the key. A public-key/secret-key pair allows a party to publish a key to the public. The public key may be used by anyone to encrypt a message to that party. The party keeps the secret key necessary to decrypt anything encrypted to that party. In general, a digital signature may be thought of as encryption using the secret key, which can be verified by a corresponding decryption using a public key. More specifically, a signature is performed by a secret-key encryption of the hash of the data to be signed, and verification involves a public-key decrypting the signed hash, and comparing the resulting value to an independently computed hash.

In steps 173 and 174 the merchant client 38 receives and verifies the remote interface server 28's certificate, as well as the remote interface server 28's signature. In response to a positive verification, the merchant client 38 generates 56 random bytes to form an MSK, and encrypts it for the remote interface server 28, designated E(pk1_S,MSK), all in step 176. In step 178 the merchant client 38 sends the encrypted MSK to the remote interface server 28.

In step 180, the remote interface server 28 reads the encrypted MSK sent from the merchant client 38. Both the merchant client 38 and the remote interface server 28 then compute the MD5(SHA1(MSK)). Specifically, in step 182 the remote interface server 28 computes the MSK by decrypting the encrypted MSK sent from the merchant client 38, and in step 184 the remote interface server 28 computes the HMAC_KEY. Again, the MSK is used for encrypting the TEAL messages and the HMAC_KEY is used for authenticating the TEAL messages. In steps 186 and 188 the merchant client 38 and the remote interface server 28, respectively, setup a TEAL internal state with MSK as the “session key” and MD5(SHA1(MSK)) as the “session authentication key”. It should be noted that the HMAC_KEY is computed by computing MD5(SHA1(MSK)).

The remote interface server 28 sends a TEAL message to the merchant client 38 containing challenge1 (20 random bytes) in step 190. In steps 191 and 192 the merchant client 38 receives challenge1 and then signs it with its first secret key. In step 193 the merchant client 38 sends the resulting signature to the remote interface server 28 along with a hash of the client's second secret key, which is stored encrypted, thus MD5(E(sym_Csk2,sk2_C)) is sent. The remote interface server 28 receives this information in step 194, and in step 196 the remote interface server 28 verifies the signature on challenge1.

In step 198 the remote interface server 28 separates the merchant client 38's authentication block from the client's certificate which was verified in step 170. Then, in step 200, the remote interface server 28 decrypts the merchant client 38's authentication block. There are two values contained in the authentication block: a hash H_Csk2 and a symmetric key sym_Csk2. The remote interface server 28 separates these keys in step 202.

In step 204 the remote interface server 28 verifies that the hash of the secret key H_Csk2 is equal to the hash the merchant client 38 sent (i.e., MD5(E(sym_Csk2,sk2_C))._In response to a positive verification, the remote interface server 28 sends the symmetric key sym_Csk2 plus challenge2 (20 random bytes) in step 206. (It should be understood that the exact number of random bytes used in any challenge may vary.)

In steps 207 and 208 the merchant client 38 receives and decrypts the second secret key sk2_C using the symmetric key sym_Csk2. In step 210 the merchant client 38 uses that decrypted key to sign challenged. Then the merchant client 38 discards the symmetric key sym_Csk2 and keeps the secret key sk2_C encrypted in storage. In step 212 the merchant client 38 sends the signature to the remote interface server 28.

The remote interface server 28 receives the signature in step 214, verifies it in step 216, and in response to positive verification completes the authentication in step 218 which permits the merchant client 38 to send a request. In step 220 the merchant client receives an acknowledgment.

In general, the method of authenticating a communication over a network of the present invention begins by a server receiving a client certificate having an authentication block. The server sends a first challenge to a client. The client signs the first challenge using a first secret key to form a first signature. The client then sends the first signature and a first hash of an encrypted form of a second secret key to a server. The server verifies the first signature. The server then decrypts the authentication block to obtain a symmetric key and a second hash, such as for example sym_Csk2 and H_Csk2 shown in FIG. 8. The server verifies that the first hash is equal to the second hash and sends the symmetric key with a second challenge to the client. The client decrypts the second secret key (e.g. sk2_C) using the symmetric key. The client signs the second challenge using the second secret key to form a second signature and sends the second signature to the server. The server then verifies the second signature. By way of example, the client may be the merchant client 38 and the server may be the remote interface server 28.

It should be understood that various alternatives to the embodiments of the invention described herein may be employed in practicing the invention. It is intended that the following claims define the scope of the invention and that structures and methods within the scope of these claims and their equivalents be covered thereby.

What is claimed is:

1. A method of conducting a transaction over a network, comprising the steps of:
establishing a wallet with a transaction manager;
using a consumer client to interact with a merchant system;
relocating the consumer client to the transaction manager; and
using the consumer client to instruct the transaction manager to pass information from the wallet to the merchant system.

2. A method in accordance with claim 1, wherein the step of using a consumer client to interact with a merchant system comprises the step of:
selecting an item of information displayed by the merchant system.

3. A method in accordance with claim 1, wherein the step of relocating the consumer client to the transaction manager comprises the step of:
sending a relocation instruction from the merchant system to the consumer client.

4. A method in accordance with claim 1, wherein the step of using the consumer client to instruct the transaction manager to pass information from the wallet to the merchant system comprises the step of:
selecting an item of information displayed by the transaction manager.

5. A method of conducting a transaction over a network, comprising the steps of:
using a consumer client to interact with a merchant system;
passing information between the merchant system and a transaction manager; and
relocating the consumer client to the transaction manager in response to the step of passing information.

6. A method in accordance with claim 5, wherein the step of using a consumer client to interact with a merchant system comprises the step of:
selecting an item of information displayed by the merchant system.

7. A method in accordance with claim 5, wherein the step of passing information between the merchant system and a transaction manager comprises the steps of:
sending a request from the merchant system to the transaction manager; and
sending a response from the transaction manager to the merchant system.

8. A method in accordance with claim 5, wherein the step of relocating the consumer client to the transaction manager in response to the step of passing information comprises the steps of:
using the information to generate a relocation instruction; and
sending the relocation instruction from the merchant system to the consumer client.

9. A method in accordance with claim 5, further comprising the step of:
using the consumer client to interact with the transaction manager;

10. A method of conducting a transaction over a network, comprising the steps of:
using a consumer client to interact with a merchant system;
relocating the consumer client to a transaction manager; and
passing information from the merchant system to the transaction manager during the step of relocating the consumer client.

11. A method in accordance with claim 10, wherein the step of using a consumer client to interact with a merchant system comprises the step of:
selecting an item of information displayed by the merchant system.

12. A method in accordance with claim 10, wherein the step of relocating the consumer client to a transaction manager comprises the step of:
sending a relocation instruction from the merchant system to the consumer client.

13. A method in accordance with claim 10, wherein the step of passing information from the merchant system to the transaction manager during the step of relocating the consumer client comprises the steps of:
appending the information to an address of the transaction manager carried by the consumer client.

14. A method in accordance with claim 10, further comprising the step of:
using the consumer client to interact with the transaction manager.

15. A method of conducting a transaction over a network, comprising the steps of:
using a consumer client to interact with a merchant system;
passing information between the merchant system and a transaction manager;
relocating the consumer client to the transaction manager;
using the consumer client to interact with the transaction manager; and
relocating the consumer client back to the merchant system.

16. A method in accordance with claim 15, wherein the step of passing information between the merchant system and a transaction manager comprises the steps of:
sending a request from the merchant system to the transaction manager; and
sending a response from the transaction manager to the merchant system.

17. A method in accordance with claim 15, wherein the step of relocating the consumer client to the transaction manager comprises the step of:
sending the relocation instruction from the merchant system to the consumer client.

18. A method in accordance with claim 15, wherein the step of using the consumer client to interact with the transaction manager comprises the step of:
selecting an item of information displayed by the transaction manager.

19. A method in accordance with claim 15, wherein the step of relocating the consumer client back to the merchant system comprises the step of:
sending information to the consumer client wherein the information includes a link back to the merchant system.

20. A method of conducting a transaction over a network, comprising the steps of:
using a consumer client to interact with a merchant system;
conducting a first communication between the merchant system and a transaction manager;
relocating the consumer client to the transaction manager;
using the consumer client to interact with the transaction manager;
relocating the consumer client back to the merchant system; and
conducting a second communication between the merchant client and the transaction manager.

21. A method in accordance with claim 20, wherein the step of conducting a first communication between the merchant system and a transaction manager comprises the steps of:
sending a first request from the merchant system to the transaction manager; and
sending a first response from the transaction manager to the merchant system.

22. A method in accordance with claim 20, wherein the step of relocating the consumer client to the transaction manager comprises the step of:
sending a relocation instruction from the merchant system to the consumer client.

23. A method in accordance with claim 20, wherein the step of using the consumer client to interact with the transaction manager comprises the step of:
selecting an item of information displayed by the transaction manager.

24. A method in accordance with claim 20, wherein the step of relocating the consumer client back to the merchant system comprises the step of:
sending information to the consumer client wherein the information includes a link back to the merchant system.

25. A method in accordance with claim 20, wherein the step of conducting a second communication between the merchant system and a transaction manager comprises the steps of:
sending a first request from the merchant system to the transaction manager; and
sending a first response from the transaction manager to the merchant system.

26. A method of conducting a transaction over a network, comprising the steps of:
using a consumer client to interact with a merchant system;
sending a first request from the merchant system to a transaction manager;
sending a first response from the transaction manager to the merchant system;
relocating the consumer client to the transaction manager;
using the consumer client to interact with the transaction manager;
relocating the consumer client back to the merchant system;
sending a second request from the merchant system to the transaction manager; and
sending a second response from the transaction manager to the merchant system.

27. A method in accordance with claim 26, wherein the first request comprises:
location information for the merchant system.

28. A method in accordance with claim 26, wherein the first response comprises:
a transaction ID.

29. A method in accordance with claim 26, wherein the second request comprises:
a transaction ID.

30. A method in accordance with claim 26, wherein the second response comprises:
a transaction information.

31. A transaction manager for use in conducting a transaction over a network, comprising:
a database server for storing consumer wallets;
a consumer client server configured to provide an interface for a consumer client on the network with the database server and to provide information from one of the consumer wallets to the consumer client; and
a remote interface server configured to pass transaction information to a merchant system coupled to the network in response to a request of the merchant system and to pass information from one of the consumer wallets to the merchant system in response to interaction of the consumer client with the consumer client server.

32. A transaction manager in accordance with claim 31, wherein the consumer wallets include payment instrument information.

33. A transaction manager in accordance with claim 31, wherein the consumer client server comprises:
a network protocol module configured to support data transfer between the consumer client and the consumer client server; and
a wallet module configured to provide a graphical user interface for display by the consumer client.

34. A transaction manager in accordance with claim 31, wherein the transaction information comprises a transaction ID and the remote interface server is configured to generate the transaction ID.

35. A transaction manager in accordance with claim 3 1, wherein the transaction information comprises relocation information to be used by the merchant system in relocating the consumer client.

36. A transaction manager in accordance with claim 3 1, wherein the remote interface server is configured to pass information from one of the consumer wallets to the merchant system in response to the consumer client designating which information is to be passed.

37. Apparatus for use in conducting a transaction over a network, comprising:
first means for storing consumer wallets;
second means for providing an interface for a consumer client on the network with the first means and for providing information from one of the consumer wallets to the consumer client; and
third means for passing transaction information to a merchant system coupled to the network in response to a request of the merchant system and for passing information from one of the consumer wallets to the merchant system in response to interaction of the consumer client with the second means.

38. A transaction manager in accordance with claim 37, wherein the consumer wallets include payment instrument information.

39. A transaction manager in accordance with claim 37, wherein the second means comprises:
fourth means for supporting data transfer between the consumer client and the second means; and
fifth means for providing a graphical user interface for display by the consumer client.

40. A transaction manager in accordance with claim 37, wherein the transaction information comprises a transaction ID and the third means comprises fourth means for generating the transaction ID.

41. A transaction manager in accordance with claim 37, wherein the transaction information comprises relocation information to be used by the merchant system in relocating the consumer client.

42. A transaction manager in accordance with claim 37, wherein the third means passes information from one of the consumer wallets to the merchant system in response to the consumer client designating which information is to be passed.

43. A network transaction system, comprising:
a network;
a merchant system coupled to the network;
a consumer client for interacting with the network; and
a transaction manager, coupled to the network, configured to store consumer wallets, pass transaction information to the merchant system in response to a request of the merchant system, and pass information from one of the consumer wallets to the merchant system in response to interaction with the transaction manager by the consumer client.

44. A network transaction system in accordance with claim 43, wherein the network comprises the Internet.

45. A network transaction system in accordance with claim 43, wherein the merchant system comprises a merchant store front.

46. A network transaction system in accordance with claim 43, wherein the consumer client comprises a web browser.

47. A network transaction system in accordance with claim 43, wherein the transaction manager comprises:
a database server for storing consumer wallets;
a consumer client server configured to provide an interface for the consumer client with the database server and to provide information from one of the consumer wallets to the consumer client; and
a remote interface server configured to pass the transaction information to the merchant system and to pass the information from one of the consumer wallets to the merchant system.

48. A method of authenticating a communication over a network, comprising the steps of:
receiving a client certificate having an authentication block;
decrypting the authentication block to obtain a symmetric key;
sending the symmetric key with a first challenge to a client;
receiving from the client a first signature that is the result of the first challenge being signed using a first secret key that was decrypted using the symmetric key; and
verifying the first signature.

49. A method in accordance with claim 48, further comprising the steps of:
before the step of decrypting the authentication block, sending a second challenge to the client;
receiving from the client a first hash of an encrypted form of the first secret key and a second signature that is a result of the second challenge being signed using a second secret key; and
verifying the second signature.

50. A method in accordance with claim 49, wherein the step of decrypting the authentication block further comprises the step of obtaining a second hash, and wherein the method further comprises the step of:
verifying that the first hash is equal to the second hash.

51. A method of authenticating a communication over a network, comprising the steps of:
sending a client certificate having an authentication block to a server;
receiving a first challenge and a symmetric key that was obtained by decrypting the authentication block;
decrypting a first secret key using the symmetric key;
signing the first challenge using the first secret key to form a first signature; and
sending the first signature to the server.

52. A method in accordance with claim 51, further comprising the steps of:
before the step of receiving a first challenge, receiving a second challenge;
signing the second challenge using a second secret key to form a second signature; and
sending the second signature and a first hash of the first secret key to the server.

53. A method in accordance with claim 52, wherein the server decrypts the authentication block to obtain a second hash and verifies that the first hash is equal to the second hash.

54. A method of authenticating a communication over a network, comprising the steps of:
receiving a client certificate having an authentication block;
sending a first challenge to a client;
receiving from the client a first signature that is a result of the first challenge being signed using a first secret key and receiving a first hash of an encrypted form of a second secret key;
verifying the first signature;
decrypting the authentication block to obtain a symmetric key and a second hash;
verifying that the first hash is equal to the second hash;
sending the symmetric key with a second challenge to the client;
receiving from the client a second signature that is a result of the second challenge being signed using the second secret key that was decrypted using the symmetric key; and
verifying the second signature.

55. A method of authenticating a communication over a network, comprising the steps of:
receiving a client certificate having an authentication block;
sending a first challenge to a client;
signing the first challenge using a first secret key to form a first signature;
sending the first signature and a first hash of an encrypted form of a second secret key to a server;
verifying the first signature;
decrypting the authentication block to obtain a symmetric key and a second hash;
verifying that the first hash is equal to the second hash;
sending the symmetric key with a second challenge to the client;
decrypting the second secret key using the symmetric key;
signing the second challenge using the second secret key to form a second signature;
sending the second signature to the server; and
verifying the second signature.
